(19) United States
(12) Patent Application Publication
(10) Pub. No.: US 2009/0058882 A1
(43) Pub. Date: Mar. 5, 2009

(54) Screen Display Device

(75) Inventors: Takao Adachi, Osaka (JP); Hideaki Yajima, Osaka (JP); Hidehiko Shin, Osaka (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 11/793,654

(22) PCT Filed: Oct. 17, 2005
(86) PCT No.: PCT/JP2005/019023

§ 371 Date: Jun. 21, 2007

(30) Foreign Application Priority Data
Jan. 5, 2005 (JP) 2005-000364

(51) Int. Cl. G09G 5/14

(52) U.S. Cl. 345/650

(57) ABSTRACT

The present invention is a screen display device (1) capable of displaying a plurality of screens on a display concurrently, and the screen display device (1) includes: a screen change event detection section (101) for detecting a screen change event which is a trigger for a change of a display content of a screen; and a screen change determination section (102) for determining, when the screen change event has been detected by the screen change event detection section (101) in a state where the plurality of screens are displayed, whether or not the display content of each of the plurality of screens displayed is to be changed. The screen display device (1) changes the display content of the screen based on a determination made by the screen change determination section (102) that the display content of the screen is to be changed.

### TECHNICAL FIELD

The present invention relates to a screen display device for displaying a screen, which is a unit of an operation object to be displayed on a display and provided to a user, and more particularly to a screen display device capable of displaying a plurality of screens.

### BACKGROUND ART

In recent years, an information processing terminal such as a mobile phone, a PDA, a digital camera, a car navigator, and a PC, which has a display for displaying character information, image information, and the like, allows a user to rotate the display. In addition, the aforementioned information processing terminal allows a display content of a screen to be changed in accordance with rotation of the display. The screen may include, for example, a screen (a selection menu) for providing a plurality of selectable menus, a screen (a pop-up panel) for notifying a user of a message, and a screen (a contents screen) for displaying contents such as character information, image information, and the like. Furthermore, the information processing terminal as described above can display a plurality of screens concurrently.

For example, in a case where the information processing terminal is a mobile phone, the display thereof may be rotatable. The mobile phone can display a screen in a vertical style, a horizontal style, or a vertical (reverse) style, in accordance with the rotation of a display portion. FIG. 17A is a diagram showing the mobile phone in the vertical style. FIG. 17B is a diagram showing the mobile phone in the horizontal style. FIG. 17C is a diagram showing the mobile phone in the vertical (reverse) style. By continuing rotating the display portion in the horizontal style, the mobile phone is in the vertical (reverse) style in which the up/down direction is reverse to that in the vertical style. In recent years, a mobile phone capable of providing display even in the vertical (reverse) style appears. As a display becomes rotatable as described above, a need arises to change the screen displayed such that a display direction of the screen, a display size of the screen, screen layout reconfiguration, operability of the screen, and the like are considered in accordance with a rotational angle of the display.

Conventionally, there has been a screen display device capable of changing a screen by automatically rearranging display positions of menu icons in accordance with a change of a display frame (see Patent Document 1).

The conventional screen display device disclosed in Patent Document 1 detects, based on a notification from a display rotation detection section for detecting rotation of a display thereof, whether the display is vertical or horizontal, and determines whether the screen displayed is to be displayed vertically or horizontally. When menu items are displayed as menu icons, the conventional screen display device reads, from a storage device, display information (a user-defined content and image display coordinates (vertically displayed/horizontally displayed)) relating to the menu icons, sets positions at which the menu icons are to be rearranged, and rearranges the menu icons. Patent Document 1: Japanese Laid-Open Patent Publication No. 10-49334

### DISCLOSURE OF THE INVENTION

### Problems to be Solved by the Invention

However, in practice, the screen is displayed in such a manner that a plurality of screens are displayed concurrently, that a plurality of screens overlap each other such that some of the plurality of screens each have its screen partially displayed, or that a screen is hidden behind another screen and therefore is not displayed on the display.

The conventional screen display device disclosed in Patent Document 1 only rearranges the menu icons based on whether the display is vertical or horizontal. Thus, Patent Document 1 does not disclose that a plurality of screens displayed are rearranged.

Further, an event, other than a change of a position of the display, in accordance with which the display content of the screen is preferably to be changed, may occur. However, Patent Document 1 only discloses a technique of changing the display content of the screen in accordance with an event in which the display has rotated, and does not disclose a technique of changing the display content of the screen in accordance with another event.

Thus, an object of the present invention is to provide a screen display device capable of changing, when a certain event occurs in a state where a plurality of screens are displayed, a display content of each of the plurality of screens.

### Solution to the Problems

To achieve the above objects, the present invention has the following features. A first aspect of the present invention is directed to a screen display device capable of displaying a plurality of screens on a display concurrently, the screen display device including: a screen change event detection section for detecting a screen change event which is a trigger for a change of a display content of a screen; and a screen change determination section for determining, when the screen change event has been detected by the screen change event detection section in a state where the plurality of screens are displayed, whether or not the display content of each of the plurality of screens displayed is to be changed, in which the display content of the screen is changed based on a determination made by the screen change determination section that the display content of the screen is to be changed.

According to the present invention, in a case where a plurality of screens are displayed concurrently, when a certain event which is the trigger for the change of the display content of the screen has occurred, it is determined whether or not the display content of each of the plurality of screens displayed is to be changed, and then the display content of the screen is changed based on the determination result. Thus, the display content of the screen is changed in accordance with the screen change event, and therefore, display can be provided to a user in an easily viewable manner.

It is preferable that the screen display device further includes: a screen management section for managing at least one displayed screen; and a screen information storage section for storing screen attribute information including changeability information, in association with styles each of which is a display form of the screen, indicating whether or not the display content of the screen is changeable in accordance with each of the styles, in which with reference to the screen attribute information stored in the screen information storage section, the screen change determination section determines, based on the changeability information corresponding to each of the styles which is to be provided after the screen change event, whether or not the display content of each of the plurality of screens is to be changed.

Consequently, the screen display device stores the changeability information in association with the styles, and it is determined, based on the changeability information corresponding to each of the styles, whether or not the display content of each of the screens is to be changed. Thus, the screen display device can easily determine, based on the changeability information stored, whether or not the display content of the screen is to be changed.

It is preferable that the screen change determination section may determine, based on upper/lower relations among the plurality of screens displayed which overlap each other, whether or not the display content of each of the plurality of screens is to be changed.

Consequently, it is determined, based on upper/lower relations among a screen displayed on a top and the screens present under the screen displayed on the top, whether or not the display contents of the screens are to be changed, and therefore, display can be provided to a user in an easily viewable manner.

For example, it is determined that the display contents of the one or more screens, among the plurality of screens, present under the screen displayed on the top thereof, are not to be changed.

Thus, the screen display device can quickly change the display contents.

For example, when the changeability information corresponding to one or more screens, among the plurality of screens, present under a screen displayed on a top thereof, indicates “changeable”, it is determined that the display contents of the one or more screens are to be changed.

Thus, even when the screen displayed on the top has ceased to be displayed, the screen display device can quickly provide to a user the screens displayed under the screen displayed on the top in an easily viewable manner.

It is preferable that when the plurality of screens displayed include at least one screen having the display content which is unchangeable, it may be determined that the display contents of all of the plurality of screens displayed are not to be changed.

Thus, all of the screens can have the same display direction, and therefore, display can be provided to a user in an easily viewable manner.

It is preferable that the screen change event detection section may detect a change of a position of the display as the event, and the screen change determination section may determine, based on the position of the display, whether or not the display content of each of the plurality of screens displayed is to be changed.

Thus, display can be provided to a user in an easily viewable manner, in accordance with rotation of the display.

It is preferable that the screen display device further includes: a screen management section for managing at least one displayed screen; and a screen information storage section for storing screen attribute information including changeability information, in association with the position of the display, indicating whether or not the display content of the screen is changeable in accordance with the position of the display, in which with reference to the screen attribute information stored in the screen information storage section, the screen change determination section determines, based on the changeability information corresponding to the position of the display which is to be provided after the change, whether or not the display content of each of the plurality of screens is to be changed.

Thus, the screen display device can easily change the display content of the screen in accordance with the rotation of the display.

It is preferable that the screen display device further includes a download section for downloading, from an external network, information relating to the screen.

Consequently, information relating to the screen can be updated, or a new screen can be added. Thus, for example, even the display content of the screen which cannot be changed in accordance with the rotation of the display can be changed, after the update or the addition, in accordance with the rotation of the display.

A second aspect of the present invention is directed to a processing method for changing, in a device capable of displaying a plurality of screens on a display concurrently, a display content of a screen, in which a screen change event which is a trigger for a change of the display content of the screen is detected, whether or not the display content of each of the plurality of screens displayed is to be changed is determined when the screen change event has been detected in a state where the plurality of screens are displayed, and the display content of the screen is changed based on a determination made that the display content of the screen is to be changed.

A third aspect of the present invention is directed to an integrated circuit capable of displaying a plurality of screens on a display concurrently, the integrated circuit including: a screen change event detection section for detecting a screen change event which is a trigger for a change of a display content of a screen; and a screen change determination section for determining, when the screen change event has been detected by the screen change event detection section in a state where the plurality of screens are displayed, whether or not the display content of each of the plurality of screens displayed is to be changed, in which the display is caused to change the display content of the screen based on a determination made by the screen change determination section that the display content of the screen is to be changed.

A fourth aspect of the present invention is directed to a program executed by a computer device capable of displaying a plurality of screens on a display concurrently, in which the computer device is caused to function as: a screen change event detection section for detecting a screen change event which is a trigger for a change of a display content of a screen; and a screen change determination section for determining, when the screen change event has been detected by the screen change event detection section in a state where the plurality of screens are displayed, whether or not the display content of each of the plurality of screens displayed is to be changed, in which the computer device is caused to change the display content of the screen based on a determination made by the screen change determination section that the display content of the screen is to be changed.

### EFFECT OF THE INVENTION

Consequently, according to the present invention, in a case where a plurality of screens are displayed concurrently, when a certain event which is the trigger for the change of the display content of the screen has occurred, it is determined whether or not the display content of each of the plurality of screens displayed is to be changed, and then the display content of the screen is changed based on the determination result. Thus, the screen display device according to the present invention can change the display content of the screen in accordance with the screen change event, and therefore, display can be provided to a user in an easily viewable manner.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a functional structure of a screen display device 1 according to an embodiment of the present invention.

FIG. 2 is a schematic diagram showing a structure of screen information.

FIG. 3 is a diagram showing an example of screen attribute information.

FIG. 4 is a flow chart showing an operation of the screen display device 1 according to the embodiment of the present invention.

FIG. 5 is a flow chart showing in detail a screen change determination process in step S207 of FIG. 4.

FIG. 6A is a diagram showing an example of display contents of screens displayed when a determination of step S310 is made.

FIG. 6B is a diagram showing an example of the screen attribute information of a screen A for which the determination of step S310 is made.

FIG. 6C is a diagram showing an example of the screen attribute information of a screen B for which the determination of step S310 is made.

FIG. 7 is a diagram showing an example of the display contents of a screen displayed when the determination of step S311 is made.

FIG. 8A is a diagram showing an example of the display contents of the screen displayed when the determination of step S310 or the determination of step S311 is made.

FIG. 8B is a diagram showing an example of the screen attribute information of the screen A for which the determination of step S310 or the determination of step S311 is made.

FIG. 8C is a diagram showing an example of screen data of the screen A.

FIG. 9A is a diagram showing an example of the display contents of the screens displayed when the determination of step S305a is made.

FIG. 9B is a diagram showing an example of the screen attribute information of a screen C for which the determination of step S305a is made.

FIG. 10 is a diagram showing an example of the display contents of the screens displayed when the determination of step S305b is made.

FIG. 11 is a diagram showing an example of the attribute information of the screen A which is a rear screen for which the determination of step S306a is made.

FIG. 12 is a diagram showing an example of the display contents of the screens displayed when the determination of step S306b is made.

FIG. 13A is a diagram showing an example of the display contents of the screens displayed when the determination of step S308 is made.

FIG. 13B is a diagram showing an example of the screen attribute information of the screen B for which the determination of step S308 is made.

FIG. 14 is a diagram showing an example of the display contents of the screens displayed when the determination of step S309b is made.

FIG. 15 is a flow chart showing another example of the screen change determination process shown in FIG. 4.

FIG. 16 is a diagram showing a hardware configuration of a computer device for executing a screen display program.

FIG. 17A is a diagram showing a mobile phone in a vertical style.

FIG. 17B is a diagram showing the mobile phone in a horizontal style.

FIG. 17C is a diagram showing the mobile phone in a vertical (reverse) style.

### DESCRIPTION OF THE REFERENCE CHARACTERS

1 screen display device
101 screen change event detection section
102 screen change determination section
103 style information storage section
104 screen management section
105 screen information storage section
106 display section
107 display
901 screen information
902 screen identifier
903 screen attribute information
904 screen data

### BEST MODE FOR CARRYING OUT THE INVENTION

With reference to the drawings, an embodiment of the present invention will be described below.

FIG. 1 is a diagram showing a functional structure of a screen display device 1 according to the embodiment of the present invention. In FIG. 1, the screen display device 1 includes a screen change event detection section 101, a screen change determination section 102, a style information storage section 103, a screen management section 104, a screen information storage section 105, a display section 106, and a display 107.

The screen information storage section 105 stores information (hereinafter, referred to as screen information) relating to displayable screens. Note that in the present invention, a screen refers to a unit of an operation object to be displayed on the display 107 by the display section 106 and provided to a user. The screen information storage section 105 stores the screen information relating to the screen currently displayed and the screen information relating to the screen which is not on display.

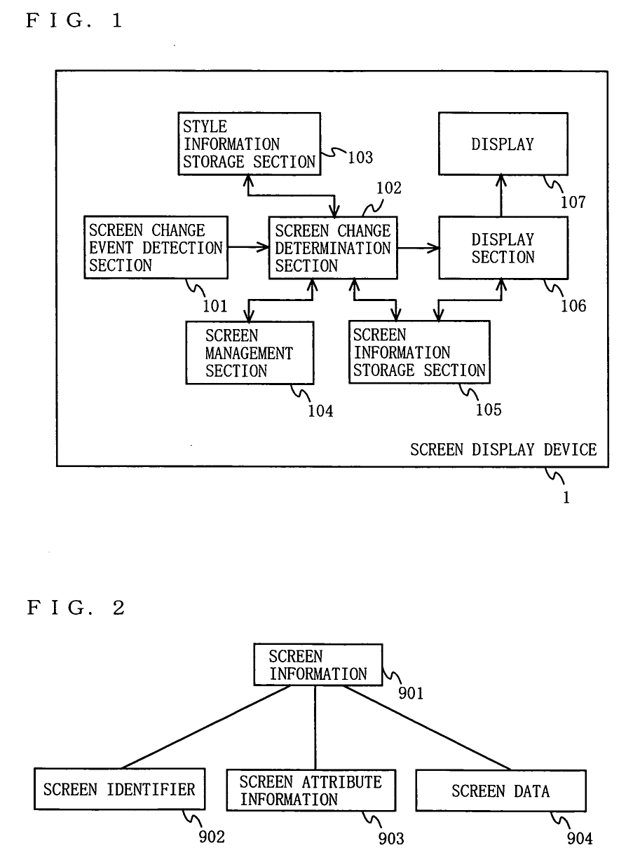

FIG. 2 is a schematic diagram showing a structure of the screen information. As shown in FIG. 2, screen information 901 includes a screen identifier 902, screen attribute information 903, and screen data 904.

The screen identifier 902 is information used for identifying a corresponding screen.

The screen attribute information 903 defines whether or not a display content of the screen is changeable in accordance with a style of the screen. The style herein refers to a display form of the screen. The style may include a vertical style, a horizontal style, a vertical (reverse) style, a horizontal (reverse) style and the like representing a rotational direction of the display 107, pattern A, pattern B and the like representing a color, Gothic, New Roman and the like representing a font, a large size, a small size and the like representing a font size, Japanese, English and the like representing a language, and a grid menu, a list menu and the like representing a menu format, for example.

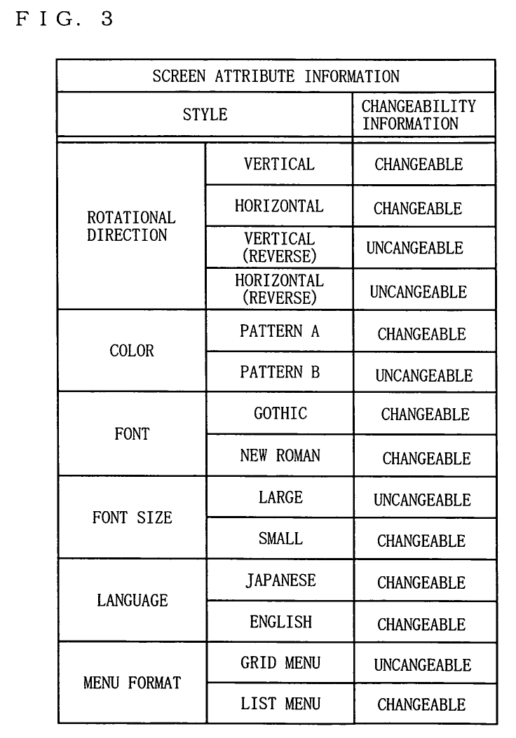

FIG. 3 is a diagram showing an example of the screen attribute information. As shown in FIG. 3, the screen attribute information includes the styles and information (hereinafter, referred to as changeability information) indicating whether or not the display content of the screen is changeable in accordance with the styles. In FIG. 3, for example, the display content of the screen is defined as changeable in accordance with the vertical style and the horizontal style, while the display content of the screen is defined as unchangeable in accordance with the vertical (reverse) style and the horizontal (reverse) style. Further, the display content of the screen is defined as changeable in accordance with, for example, Gothic and New Roman each of which represents the style of the font.

The screen data 904 is data relating to the display content of the screen. The screen information storage section 105 stores the screen data 904 in association with the style. The screen information storage section 105 stores, as the screen data 904, a screen layout, image data, and data relating to key mapping, in accordance with, for example, whether the display is vertical or horizontal.

The screen management section 104 stores the screen identifier 902 of each of the screens currently displayed on the display, so as to manage the screens currently displayed.

The style information storage section 103 stores a current style.

The screen change event detection section 101 detects an occurrence of an event (hereinafter, referred to as a screen change event) which is a trigger for a change of the display content of the screen. An example of the screen change event may include rotation of the display 107, an instruction for a change of the color, an instruction for a change of the font, an instruction for a change of the font size, an instruction for a change of the language, and an instruction for a change of the menu format. When the rotation of the display 107, for example, is used as the screen change event, the screen change event detection section 101 detects, as the screen change event, a signal from a sensor or the like provided in a mechanism for rotating the display 107. Further, when the instruction for the change of the color, for example, is used as the screen change event, the screen change event detection section 101 detects, as the screen change event, a notification from an application for receiving the change of the color. When detecting the screen change event, the screen change event detection section 101 recognizes the style to be provided after the screen change event and notifies the screen change determination section 102 of the style. An event to be used as the screen change event may be preset or may be set by a user and the like later.

When a change of the style has been notified by the screen change event detection section 101, the screen change determination section 102 recognizes, with reference to the style information storage section 103, the current style, and also recognizes, with reference to the screen management section 104, the screen identifier of each of the screens currently displayed. The screen change determination section 102 obtains, with reference to the screen information storage section 105, the screen attribute information corresponding to the screen identifier having been recognized, determines whether or not the display content of each of the screens currently displayed is to be changed, and notifies the display section 106 of the determination result. The screen change determination section 102 causes the style information storage section 103 to store the current style. Note that when the display 107 has rotated, the screen change determination section 102 determines, as the current style, a direction of the display 107 having rotated. In a case where the style is not changed in accordance with the rotation of the display 107, i.e., for example, a case where the style representing the color, the font, the font size, the language, the menu format, and the like is changed, the screen change determination section 102 causes the style information storage section 103 to update the current style only when the screen change determination section 102 has determined that the display content of the screen is to be changed.

When the display section 106 has been notified by the screen change determination section 102 that the display content of a screen is to be changed, the display section 106 obtains, from the screen information storage section 105, screen data corresponding to the style to be provided after the change, regarding the screen having the display content to be changed, and notifies the display 107 of a content to be displayed.

The display 107, the display 107, which may be a liquid crystal display (Liquid Crystal Display: LCD) or the like, displays the screen based on a notification content from the display section 106. The display 107 changes, based on the content to be displayed which has been notified by the display section 106, the display content of the screen displayed.

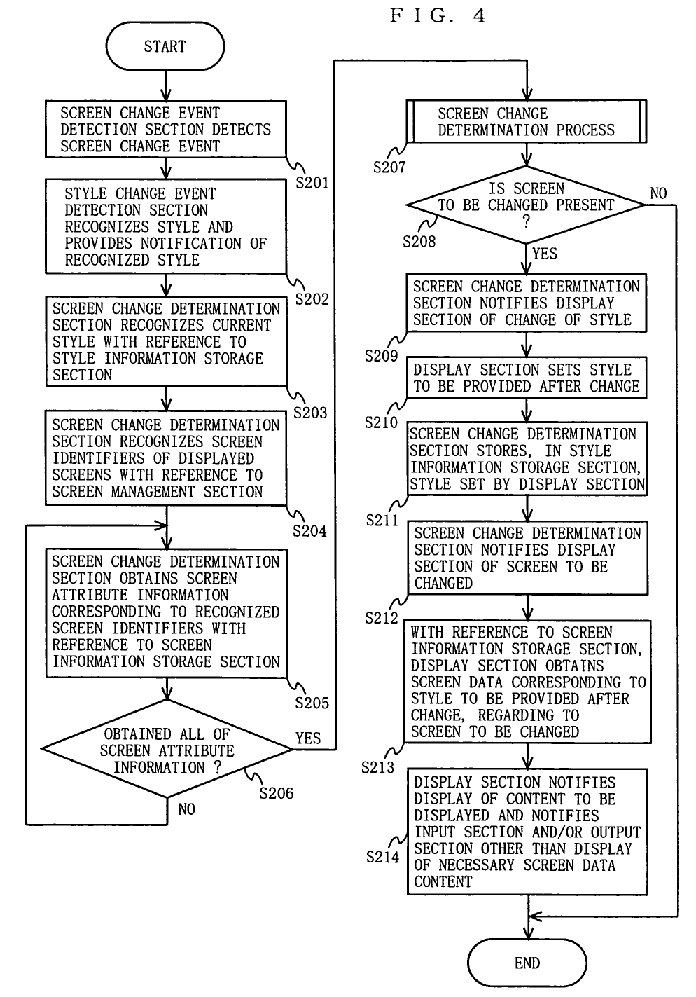

FIG. 4 is a flow chart showing an operation of the screen display device 1 according to the present embodiment. With reference to FIG. 4, the operation of the screen display device 1 according to the present embodiment will be described below.

Firstly, the screen change event detection section 101 detects the screen change event, thereby starting the operation (step S201). For example, in a case where the rotation of the display 107 is used as the screen change event, the screen change event detection section 101 detects that the screen change event has occurred when the display 107 has rotated.

The screen change event detection section 101 then recognizes the style to be provided after the screen change event, and notifies the screen change determination section 102 of the style having been recognized (step S202).

The screen change determination section 102 then recognizes, with reference to the style information storage section 103, the current style (step S203).

The screen change determination section 102 then recognizes, with reference to the screen management section 104, the screen identifier of each of the screens currently displayed (step S204).

The screen change determination section 102 then obtains, with reference to the screen information storage section 105, the screen attribute information corresponding to the screen identifier having been recognized in step S204 (step S205).

The screen change determination section 102 then determines whether or not the screen attribute information of all of the screens currently displayed has been obtained (step S206). When the screen attribute information of all of the screens has not been obtained, the screen change determination section 102 returns to the operation of step S205 so as to continue to obtain the screen attribute information. On the other hand, when the screen attribute information of all of the screens has been obtained, the screen change determination section 102 proceeds to the operation of step S207.

In step S207, the screen change determination section 102 performs a process (hereinafter, referred to as a screen change determination process) for determining a screen having the display content to be changed, based on the current style, the style to be provided after the screen change event, and upper/lower relations among all of the overlapping screens displayed.

After step S207, the screen change determination section 102 determines whether or not the screen having the display content to be changed is present (step S208). When the screen having the display content to be changed is not present, the screen change determination section 102 ends the process. Note, however, that when the screen change event has been detected based on the rotation of the display 107, the screen change determination section 102 causes the style information storage section 103 to store, as the current style, the direction of the display 107 having rotated, and ends the process. Except when the display 107 has rotated, the screen change determination section 102 does not change a content stored in the style information storage section 103, and ends the process.

When the screen having the display content to be changed is present, the screen change determination section 102 proceeds to the operation of step S209. In step S209, the screen change determination section 102 notifies the display section 106 of the change of the style. The display section 106 sets, in accordance with a notification of the change of the style, the style to be provided after the change (step S210).

The screen change determination section 102 then stores, in the style information storage section 103, the style having been set by the display section 106 (step S211).

The screen change determination section 102 then notifies the display section 106 of the screen having the display content to be changed (step S212).

The display section 106 then obtains, with reference to the screen information storage section 105, the screen data corresponding to the style to be provided after the change, regarding the screen having the display content to be changed (step S213).

Based on the screen data having been obtained, the display section 106 then notifies the display 107 of the content to be displayed, also notifies, of necessary screen data (e.g., key mapping), an input section and/or an output section (not shown) other than the display (step S214), and ends the process. In response thereto, the display displays the screen to be displayed after the change. Additionally, the input section and/or the output section (not shown) other than the display change an input content and/or an output content, based on the screen data having been notified of.

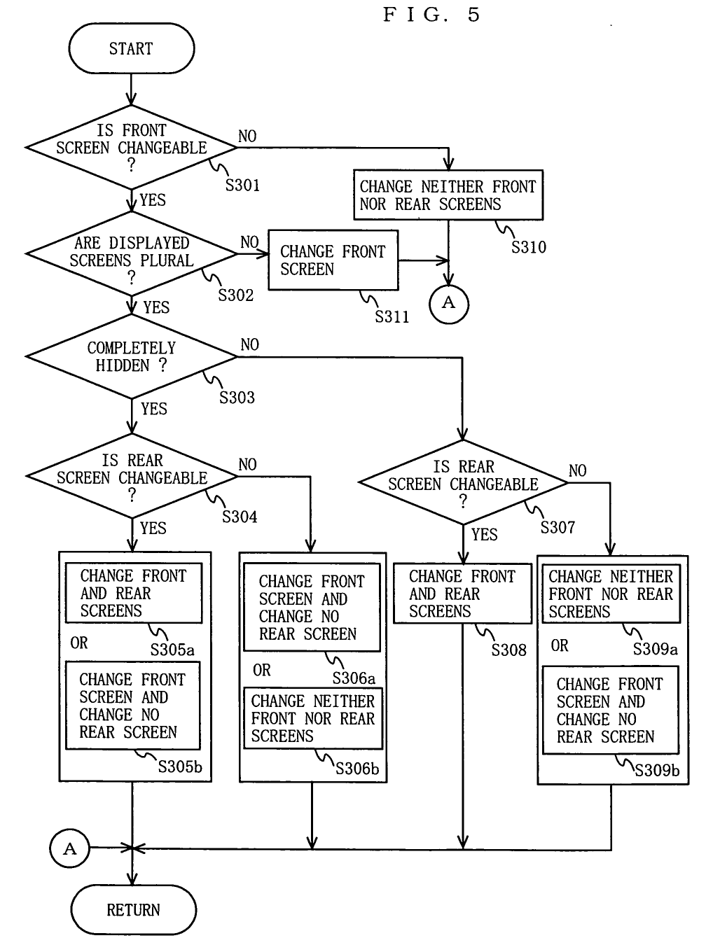

FIG. 5 is a flow chart showing in detail the screen change determination process in step S207 of FIG. 4. In the screen change determination process, the screen change determination section 102 determines, among the screens displayed, a screen having the display content to be changed. When the style to be provided after the screen change event is not the same as the current style having been recognized in step S203, the screen change determination section 102 determines whether or not the screen displayed is changeable in accordance with the style to be provided after the screen change event. In contrast, even when the style to be provided after the screen change event is the same as the current style having been recognized in step S203, since the screen information storage section 105 may store a plurality of screen data corresponding to one and the same style, the screen change determination section 102 determines, based on screen data different from the screen data used for the screen currently displayed, whether or not the display content of the screen is to be changed. In FIG. 5, in a case where the style to be provided after the screen change event is the same as the current style, even when the changeability information corresponding to the style to be provided after the screen change event indicates “changeable”, the screen change determination section 102 determines that the screen displayed is changeable only when the screen data different from the screen data corresponding to the screen displayed is present. The screen change determination section 102 notifies the display section 106 that the screen data different from the screen data corresponding to the screen displayed is the screen data to be used after the change. Note that a case where the style to be provided after the screen change event is the same as the current style having been recognized in step S203, may be a case where, for example, the display 107 is changed from being in a vertical state to being in a slightly inclined state and then changed back to being in the original vertical state. With reference to FIG. 5, the operation of the screen display device 1 in the screen change determination process will be described below.

Firstly, the screen change determination section 102 determines whether or not the display content of the screen (hereinafter, referred to as a front screen) displayed on a top is changeable (step S301). Specifically, the screen change determination section 102 recognizes the screen identifier of the front screen, also recognizes the style to be provided after the screen change event, and then recognizes, with reference to the screen information storage section 105, the changeability information which is included in the screen attribute information corresponding to the screen identifier having been recognized and which corresponds to the style having been recognized. The screen change determination section 102 then determines, based on the changeability information having been recognized, whether or not the display content of the front screen is changeable.

When the front screen is unchangeable, the screen change determination section 102 determines that the display contents of the front screen and a screen (hereinafter, referred to as a rear screen) present behind (under) the front screen are not to be changed (step S310).

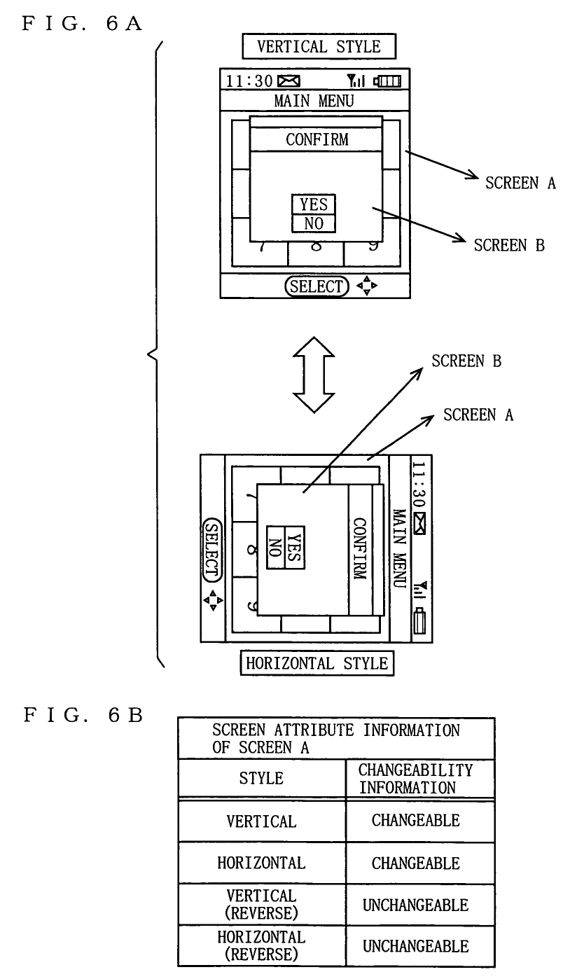

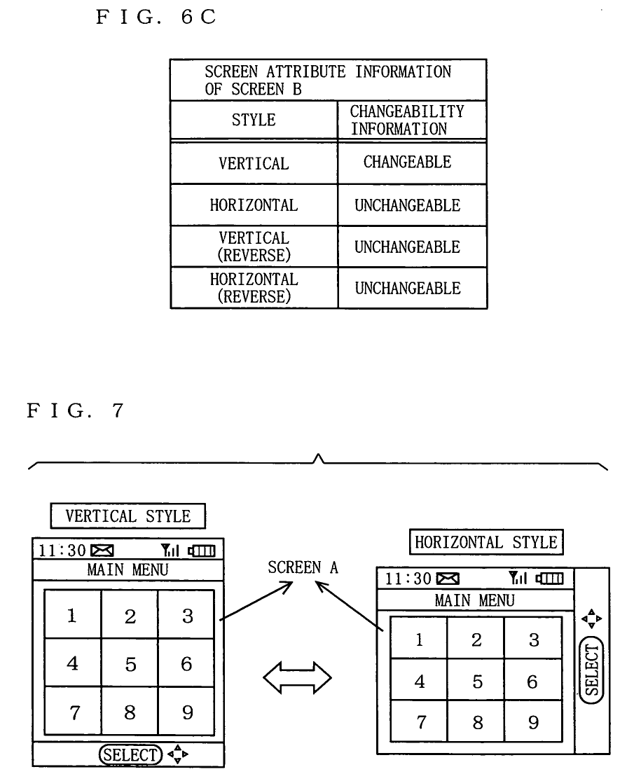

FIG. 6A is a diagram showing an example of the display contents of the screens displayed when a determination of step S310 is made. FIG. 6B is a diagram showing an example of the screen attribute information of a screen A for which the determination of step S310 is made. FIG. 6C is a diagram showing an example of the screen attribute information of a screen B for which the determination of step S310 is made. As shown in FIG. 6A, when the screen B is the front screen and the screen A is the rear screen, the screen change determination section 102 recognizes, with reference to the attribute information of the screen B which is the front screen, whether or not the changeability information corresponding to the style to be provided after the change indicates “changeable”. In the example shown in FIG. 6C, the changeability information corresponding to the style (the horizontal style) to be provided after the change indicates “unchangeable”, and therefore, the screen change determination section 102 determines that the display contents of the front screen and the rear screen are not to be changed, regardless of the change ability information, as shown in the example of FIG. 6B, corresponding to the horizontal style of the screen A which is the rear screen.

When it has been determined in step S301 that the front screen is changeable, the screen change determination section 102 determines, with reference to the screen management section 104, whether or not the screens currently displayed are plural (step S302). When not a plurality of the screens but a single screen is displayed, the screen change determination section 102 determines that the display content of the front screen is to be changed (step S311).

FIG. 7 is a diagram showing an example of the display contents of the screen displayed when the determination of step S311 is made. In the example shown in FIG. 7, the screen attribute information shown in FIG. 6B is used as the screen attribute information of the screen A. As shown in FIG. 7, when the style is changed from the vertical style to the horizontal style, the screen display device 1 changes the display content of the screen A.

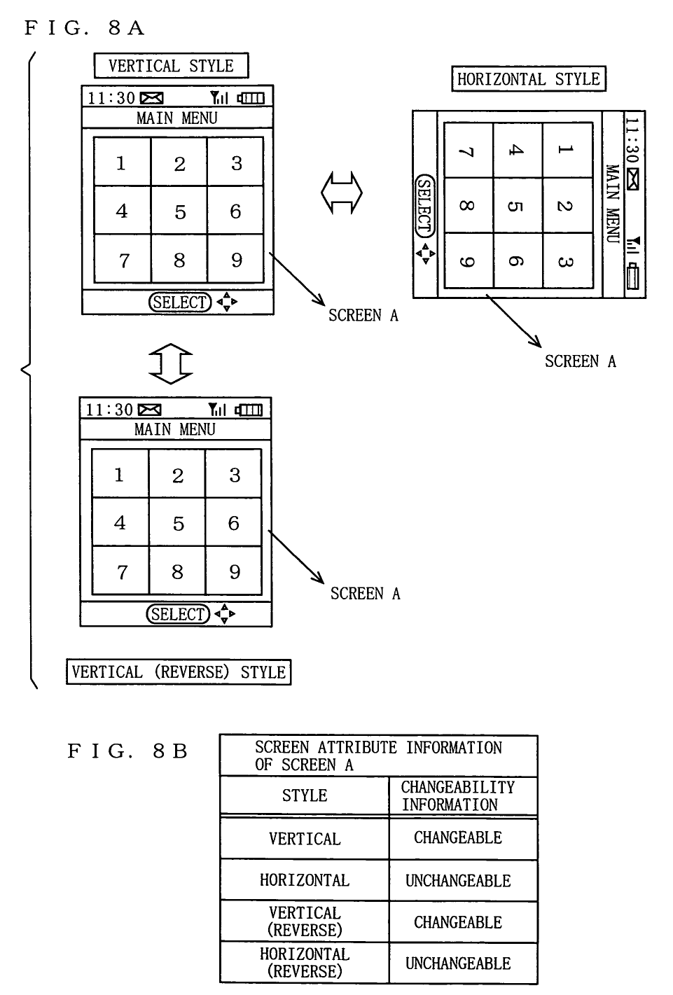

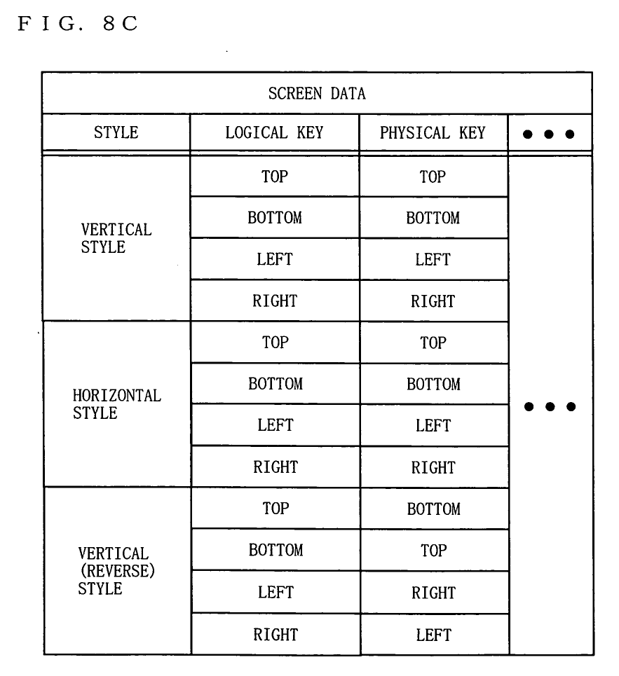

FIG. 8A is a diagram showing an example of the display contents of the screen displayed when the determination of step S310 or the determination of step S311 is made. FIG. 8B is a diagram showing an example of the screen attribute information of the screen A for which the determination of step S310 or the determination of step S311 is made. FIG. 8C is a diagram showing an example of the screen data of the screen A. As shown in FIG. 8A, when the style is changed from the vertical style to the horizontal style, since the changeability information corresponding to the horizontal style indicates “unchangeable” (see FIG. 8B), the screen change determination section 102 determines that the front screen is not to be changed (see step S310). As shown in FIG. 8A, when the style is changed from the vertical style to the vertical (reverse) style, since the changeability information corresponding to the vertical (reverse) style indicates “changeable” (see FIG. 8B), the screen change determination section 102 determines that the front screen is to be changed (see step S311). Note that, as shown in step S214 of FIG. 4, the display section 106 notifies, of the necessary screen data such as key mapping, the input section and/or the output section (not shown) other than the display 107. FIG. 8C is a diagram showing an example of the screen data (key mapping) notified of in the example shown in FIG. 8A. As shown in FIG. 8C, the screen display device 1 is required to change the screen data into necessary data when the style has been changed. The same is true of not only step S311 but also steps S310, S305a, S305b, S306a, S308 and S309b.

When it has been determined in step S302 that the screens displayed are plural, the screen change determination section 102 determines whether or not the rear screen is completely hidden behind the front screen (step S303). Note that the operation performed in and after step S303 is performed for each rear screen.

When the rear screen is completely hidden, the screen change determination section 102 determines, based on the changeability information of the screen attribute information corresponding to the style to be provided after the change, whether or not the display content of the rear screen is changeable (step S304).

When it has been determined in step S304 that the rear screen is changeable, the screen change determination section 102 determines that the front screen and the rear screen are to be changed (step S305a) or determines that the front screen is to be changed and the rear screen is not to be changed (step S305b). Whether the determination of step S305a or the determination of step S305b is made may be preset in the screen display device 1 or may be selected by a user.

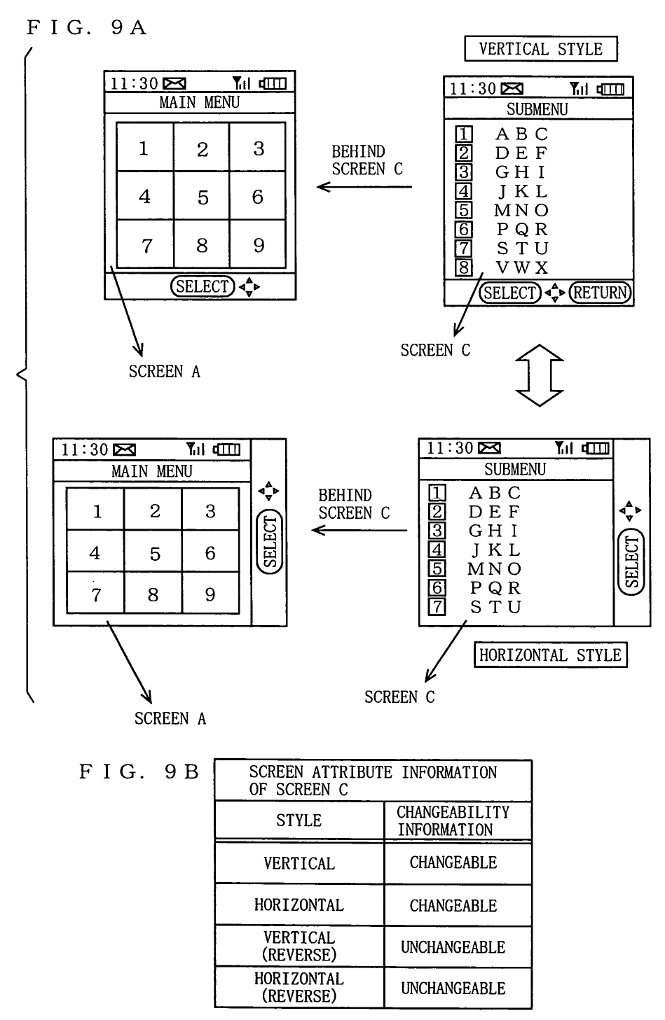

FIG. 9A is a diagram showing an example of the display contents of the screens displayed when the determination of step S305a is made. FIG. 9B is a diagram showing an example of the screen attribute information of a screen C for which the determination of step S305a is made. FIG. 6B is used for showing the screen attribute information of the screen A for which the determination of step S305a is made. Thus, in a state where the screen A which is the rear screen is completely hidden behind the screen C which is the front screen, when the display contents of the screens A and C are changeable in accordance with the horizontal style, the screen display device 1 changes the display contents of the screens A and C. Thus, the display content of the rear screen completely hidden is also changed, and therefore, the rear screen easily viewable to a user can be quickly displayed when the front screen disappears.

FIG. 10 is a diagram showing an example of the display contents of the screens displayed when the determination of step S305b is made. FIG. 9B and FIG. 6B are used for showing the screen attribute information of the screens C and A, respectively. As shown in FIG. 10, in a state where the screen A which is the rear screen is completely hidden behind the screen C which is the front screen, when the display contents of the screens A and C are changeable in accordance with the horizontal style, it is determined that the display content of the front screen is to be changed but the display content of the rear screen is not to be changed. Therefore, the screen display device 1 can perform the change of the display content of the screen quickly, since the display content of the rear screen is not changed. Thus, when it is determined that the display content of the rear screen is not to be changed, it is efficient in processing speed.

When it has been determined in step S304 that the rear screen is unchangeable, the screen change determination section 102 determines that the front screen is to be changed and the rear screen is not to be changed (step S306a) or determines that the front screen and the rear screen are not to be changed (step S306b). Whether the determination of step S306a or the determination of step S306b is made may be preset in the screen display device 1 may be selected by a user.

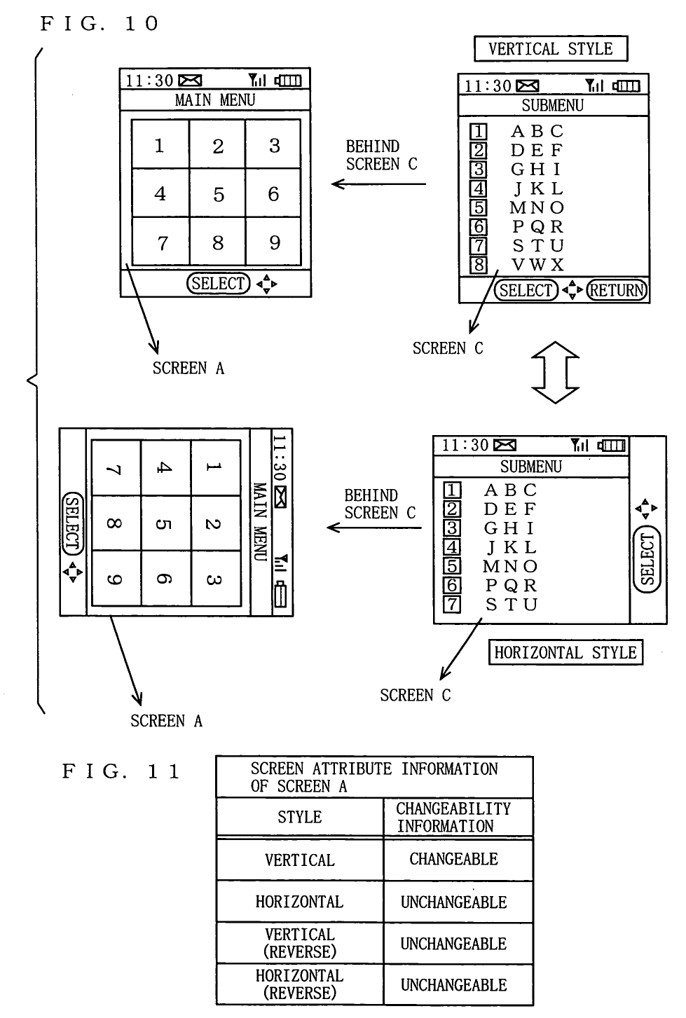

FIG. 11 is a diagram showing an example of the attribute information of the screen A which is the rear screen for which the determination of step S306a is made. FIG. 10 is used for showing an example of the display contents of the screens displayed when the determination of step S306a is made. Thus, when the rear screen is unchangeable, the screen display device 1 changes only the display content of the front screen. Note that the screen attribute information of a screen may be different depending on whether the screen is the front screen or the rear screen. In the example shown in FIG. 10, for example, only when the screen A is the rear screen, it may be determined, based on the screen attribute information shown in FIG. 11, that the display content of the screen A is unchangeable in accordance with the horizontal style.

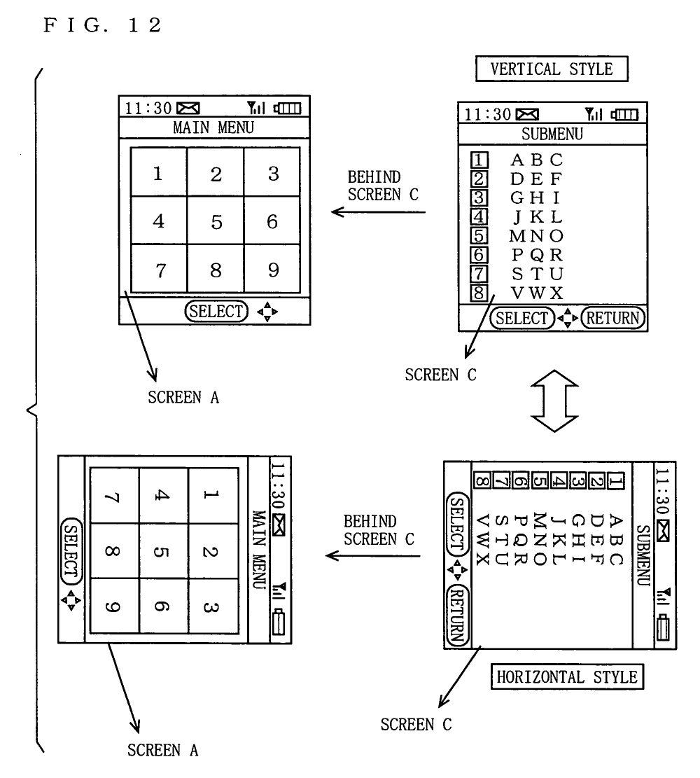

FIG. 12 is a diagram showing an example of the display contents of the screens displayed when the determination of step S306b is made. FIG. 11 and FIG. 9B are used for showing the screen attribute information of the screens A and C, respectively, for which the determination of step S306b is made. Thus, when the rear screen is unchangeable, the screen display device 1 may change neither the display content of the front screen nor the display content of the rear screen. Thus, processing load and delay caused by the changes of the display contents of the screens may be reduced.

When it has been determined in step S303 that the rear screen is not completely hidden, the screen change determination section 102 determines, based on the changeability information of the screen attribute information corresponding to the style to be provided after the change, whether or not a display content of the rear screen is changeable (step S307).

When it has been determined in step S307 that the rear screen is changeable, the screen change determination section 102 determines that the front screen and the rear screen are to be changed (step S308).

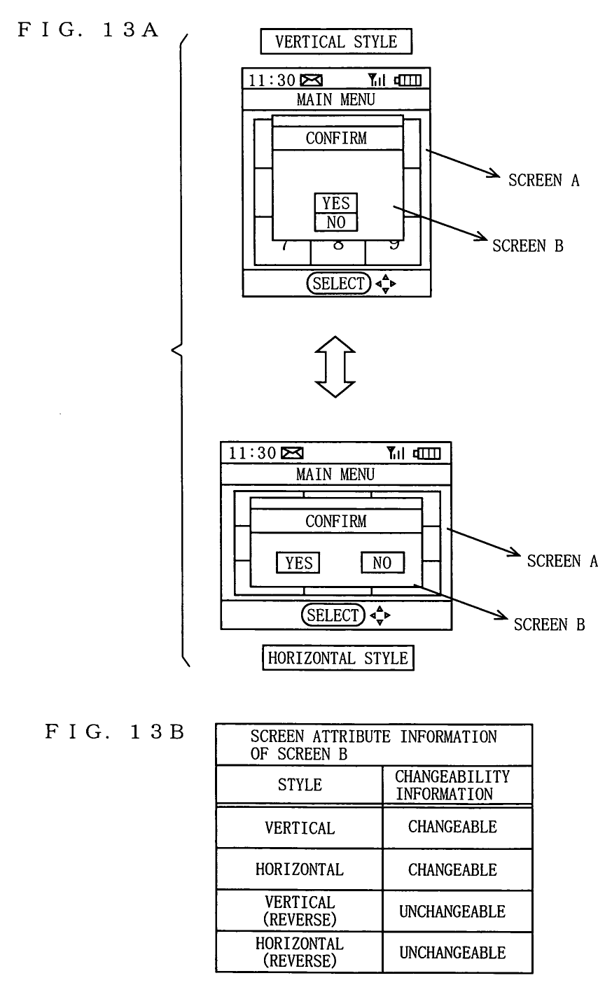

FIG. 13A is a diagram showing an example of the display contents of the screens displayed when the determination of step S308 is made. FIG. 13B is a diagram showing an example of the screen attribute information of the screen B for which the determination of step S308 is made. FIG. 6B is used for showing the attribute information of the screen A for which the determination of step S308 is made. Thus, in a state where the screen A which is the rear screen is partially hidden behind the screen B which is the front screen, when the display contents of the screens A and B are changeable in accordance with the horizontal style, the screen display device 1 changes the display contents of the screens A and B. Thus, the display content of the rear screen partially hidden is also changed, and therefore, the rear screen easily viewable to a user can be quickly displayed when the front screen disappears.

When it has been determined in step S307 that the rear screen is unchangeable, the screen change determination section 102 determines that the front screen and the rear screen are not to be changed (step S309a) or determines that the front screen is to be changed and the rear screen is not to be changed (step S309b). Whether the determination of step S309a or the determination of step S309b is made may be preset in the screen display device 1 or may be selected by a user.

FIG. 6A is used for showing an example of the display contents of the screens displayed when the determination of step S309a is made. FIG. 11 and FIG. 9B are used for showing the screen attribute information based on which the determination of step S309a is made.

FIG. 14 is a diagram showing an example of the display contents of the screens displayed when the determination of step S309b is made. FIG. 11 and FIG. 13B are used for showing the screen attribute information of the screens A and B, respectively, for which the determination of step S309b is made. When the rear screen is unchangeable, the screen display device 1 changes only the display content of the front screen. Note that the screen attribute information of a screen may be different depending on whether the screen is the front screen or the rear screen.

As described above, according to the embodiment of the present invention, for example, in a case where a plurality of screens are displayed concurrently, a case where a plurality of screens overlap each other such that some of the plurality of screens each have its screen partially displayed, or a case where a screen is hidden behind another screen and therefore is not displayed on the display, when a certain event which is the trigger for the change of the display content of the screen has occurred, the screen display device 1 can determine, based on the screen attribute information relating to the screen displayed, whether or not the display content of the screen is to be changed, and can change, based on the determination result, the display content of the screen. Thus, when the style is changed, for example, when the display is rotated, or the color, the font, the font size, the language, the menu format, and the like are changed, the display content of the screen displayed is to be changed in accordance with the style, and therefore, the screen display device 1 can provide display to a user in an easily viewable manner.

For example, in a case where the display has rotated, when all of the screens displayed are changeable in accordance with the style to be provided after the rotation, all of the screens displayed have the same display direction (see steps S305a and S308 in FIG. 5, for example), and therefore, display can be provided to a user in an easily viewable manner.

Note that in a case where the rotation of the display 107 leads to the change of the display content of the screen, when the screen data to be used after the change is defined as being represented within a display area of the display for the style to be provided after the change, the screen display device 1 can display, even based on the rotation of the display 107, the screen to be displayed within the display area.

Note that the screen change determination process (step S207) shown in FIG. 4 is not limited to the operation shown in FIG. 5, and may be any process for determining whether or not the display content of the screen is changeable.

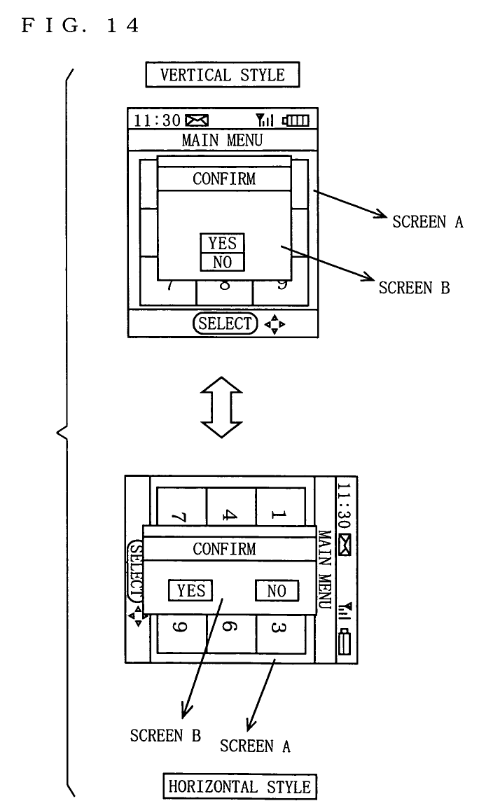

FIG. 15 is a flow chart showing another example of the screen change determination process shown in FIG. 4. With reference to FIG. 15, the operation of the screen display device 1 in said another example of the screen change determination process shown in FIG. 4 will be described below.

Firstly, the screen change determination section 102 determines, based on the changeability information which is included in the screen attribute information of the screens displayed and which corresponds to the style to be provided after the change, whether or not the screens displayed include at least one screen having the display content which is unchangeable (step S401).

When the screens displayed include at least one screen having the display content which is unchangeable, the screen change determination section 102 determines that the display contents of all of the screens are not to be changed (step S402). When the display contents of all of the screens are changeable, the screen change determination section 102 determines that the display contents of all of the screens are to be changed (step S403).

As a result, in a state where a plurality of screens are displayed, only when the display contents of all of the plurality of screens are changeable, the screen display device 1 changes the display contents of all of the plurality of screens. Accordingly, for example, in a case where the display 107 has rotated, when the display contents of all of the plurality of screens are changeable, all of the plurality of screens can have the same display direction. On the other hand, even when the plurality of screens include at least one screen having the display content which is unchangeable, all of the plurality of screens can also have the same display direction. Thus, the screen display device which can display the screens easily viewable to a user can be provided.

Note that in the screen display device 1 shown in FIG. 1, a screen information download section which can download the screen information from an external network may be provided. Thus, the screen display device 1 can change, through the download, the screen information stored in the screen information storage section 105.

Note that in the screen display device 1 shown in FIG. 1, a screen attribute information download section which can download the screen attribute information from an external network may be provided. Thus, the screen display device 1 can change, through the download, the screen attribute information stored in the screen information storage section 105.

Note that in a case where the screen attribute information is used for an application having one or more screens, the screen display device 1 may notify the application of the changes of the display contents, so as to change the display contents of the one or more screens.

Note that in a case where a display size of the screen having been changed through the download does not match the display size of the display 107, the screen display device 1 may change the screen attribute information so as to set the display content of the screen as unchangeable in accordance with the display size of the screen having been changed through the download.

Note that the screen change event detection section 101 may detect and perform the change of the style based on a change of a shape of an information processing terminal, such as opening and closing of a foldable information processing terminal or a change of a position of a slidable display, as well as the rotation of the display 107.

The screen change event detection section 101 can detect, as the rotational direction of the display 107, not only the vertical style, the horizontal style, the vertical (reverse) style, and the horizontal (reverse) style as shown in the above-described embodiment, but also an arbitrary rotational direction. In this case, the screen display device 1 holds the screen attribute information and the screen data which correspond to an arbitrary position of the display 107, and determines, in accordance with a position of the display 107, whether or not the display content of the screen is to be changed. When it has been determined that the display content of the screen is to be changed, the display content of the screen may be changed in accordance with the position of the display 107.

Note that in a case where the screen is displayed on a display having separate display areas, the present invention can also be applied to each of the separate display areas.

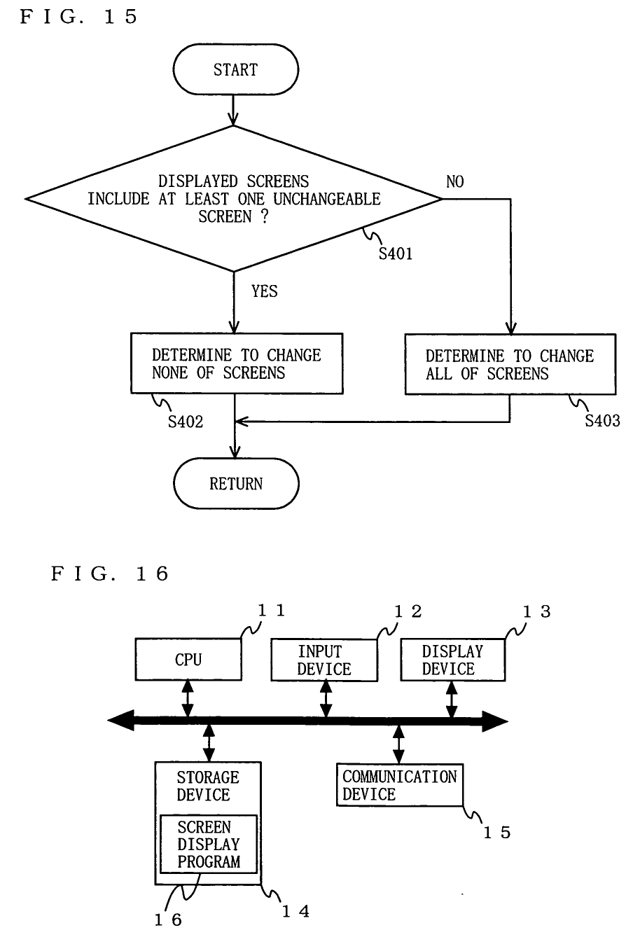

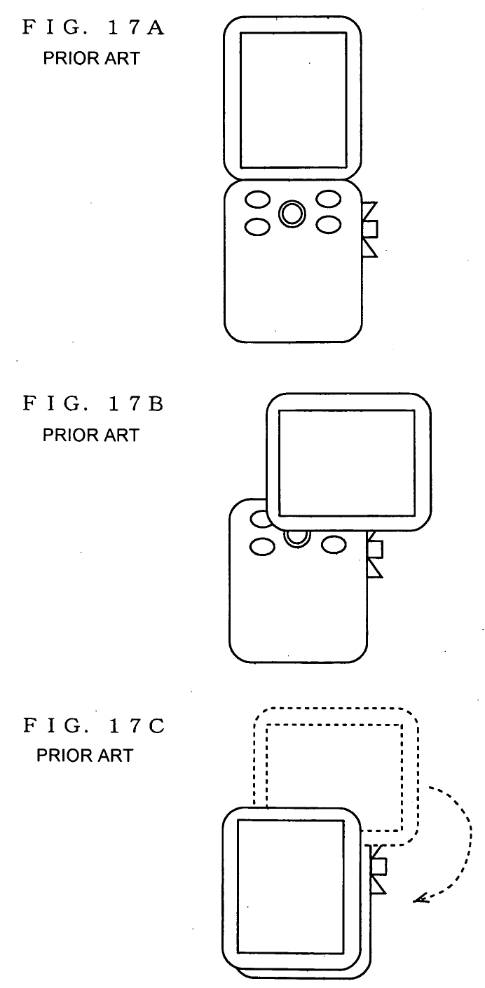

Note that the screen display device described in the above-described embodiment can be realized by causing a computer device to execute a screen display program which allows the operation described in the above embodiment to be performed. FIG. 16 is a diagram showing a hardware structure of the computer device for executing the screen display program. In FIG. 16, the computer device includes a CPU 11, an input device 12, a display device 13, a storage device 14, and a communication device 15. The storage device 14 stores a screen display program 16. The CPU 11 can perform the operation described in the above embodiment by executing the screen display program 16.

Note that a recording medium used for the storage device 14, in which the screen display program is stored, is not particularly specified and includes a ROM, a RAM, a semiconductor memory such as a flash memory, a magnetic disk memory such as a flexible disk and a hard disk, an optical disk such as a CD-ROM, a DVD and a BD, a memory card, or the like. The recording medium referred to herein is a notion including a communication medium such as a telephone line and a carrier line.

Note that the screen display device 1 may be realized as an LSI, which is an integrated circuit. This functional block may be constructed in a chip form, or all or some of the functional blocks may be constructed in a chip form. Typically, the screen change event detection section 101, the screen change determination section 102, the style information storage section 103, the screen management section 104, and the screen information storage section 105 are integrated. The LSI referred to herein may be referred to as an IC, a system LSI, a super LSI, or an ultra LSI, depending on the degree of integration. Also, the method of integration is not limited to LSI, and may be realized by a dedicated circuit or a general-purpose processor. Further, an FPGA (Field Programmable Gate Array), which can be programmed after LSI manufacture, or a reconfigurable processor enabling connections and settings of the circuit cells in the LSI to be reconfigured may be used. Furthermore, in a case where another integration technology replacing LSI becomes available due to improvement of a semiconductor technology or due to emergence of another technology derived therefrom, integration of the functional blocks may be performed by using such a technology. For example, biotechnology may be applied thereto.

While the invention has been described in detail, the foregoing description is in all aspects illustrative and not restrictive. It is understood that numerous other modifications and variations can be devised without departing from the scope of the invention.

### INDUSTRIAL APPLICABILITY

The screen display device according to the present invention can change, when a certain event has occurred in a state where a plurality of screens are displayed, the display content of each of the plurality of screens, and is useful for an information terminal and the like such as a mobile phone, a PCD, or a digital camera. Further, the present invention can also be applied to an information processing terminal and the like such as a PC or a car navigator, which has a display for providing display.

1. A screen display device capable of displaying a plurality of screens on a display concurrently, the screen display device comprising:
a screen change event detection section for detecting a screen change event which is a trigger for a change of a display content of a screen; and
a screen change determination section for determining, when the screen change event has been detected by the screen change event detection section in a state where the plurality of screens are displayed, whether or not the display content of each of the plurality of screens displayed is to be changed, wherein
the screen change determination section determines, based on upper/lower relations among the plurality of screens displayed which overlap each other, whether or not the display content of each of the plurality of screens is to be changed, and
the display content of the screen is changed based on a determination made by the screen change determination section that the display content of the screen is to be changed.

2. The screen display device according to claim 1, further comprising:
a screen management section for managing at least one displayed screen; and
a screen information storage section for storing screen attribute information including changeability information, in association with styles each of which is a display form of the screen, indicating whether or not the display content of the screen is changeable in accordance with each of the styles, wherein
with reference to the screen attribute information stored in the screen information storage section, the screen change determination section determines, based on the changeability information corresponding to each of the styles which is to be provided after the screen change event, whether or not the display content of each of the plurality of screens is to be changed.

3. (canceled)

4. The screen display device according to claim 1, wherein the screen change determination section determines that the display contents of one or more screens, among the plurality of screens, present under a screen displayed on a top thereof, are not to be changed.

5. The screen display device according to claim 2, wherein, when the changeability information corresponding to one or more screens, among the plurality of screens, present under a screen displayed on a top thereof, indicates “changeable”, the screen change determination section determines that the display contents of the one or more screens are to be changed.

6. The screen display device according to claim 1, wherein, when the plurality of screens displayed include at least one screen having the display content which is unchangeable, the screen change determination section determines that the display contents of all of the plurality of screens displayed are not to be changed.

7-8. (canceled)

9. The screen display device according to claim 1, further comprising a download section for downloading, from an external network, information relating to the screen.

10. A processing method for changing, in a device capable of displaying a plurality of screens on a display concurrently, a display content of a screen, wherein
a screen change event which is a trigger for a change of the display content of the screen is detected,
whether or not the display content of each of the plurality of screens displayed which overlap each other is to be changed is determined based on upper/lower relations among the plurality of screens, when the screen change event has been detected in a state where the plurality of screens are displayed, and
the display content of the screen is changed based on a determination made that the display content of the screen is to be changed.

11. An integrated circuit capable of displaying a plurality of screens on a display concurrently, the integrated circuit comprising:
a screen change event detection section for detecting a screen change event which is a trigger for a change of a display content of a screen; and
a screen change determination section for determining, when the screen change event has been detected by the screen change event detection section in a state where the plurality of screens are displayed, whether or not the display content of each of the plurality of screens displayed is to be changed, wherein
the screen change determination section determines, based on upper/lower relations among the plurality of screens displayed which overlap each other, whether or not the display content of each of the plurality of screens is to be changed, and
the display is caused to change the display content of the screen based on a determination made by the screen change determination section that the display content of the screen is to be changed.

12. A program executed by a computer device capable of displaying a plurality of screens on a display concurrently, wherein
the computer device is caused to function as:
a screen change event detection section for detecting a screen change event which is a trigger for a change of a display content of a screen; and
a screen change determination section for, when the screen change event has been detected by the screen change event detection section in a state where the plurality of screens are displayed, determining, based on upper/lower relations among the plurality of screens which overlap each other, whether or not the display content of each of the plurality of screens displayed is to be changed, wherein
the computer device is caused to change the display content of the screen based on a determination made by the screen change determination section that the display content of the screen is to be changed.
